(19) United States
(12) Patent Application Publication
(10) Pub. No.: US 2014/0239082 A1
(43) Pub. Date: Aug. 28, 2014

(54) VARIABLE ORIFICE SPRAY HEAD OF LIQUID DELIVERY SYSTEM AND CALIBRATION SYSTEM

(71) Applicant: CATERPILLAR INC., Peoria, IL (US)

(72) Inventors: David C. Freeman, Chillicothe, IL (US); Brian W. Mann, Edwards, IL (US); Balamurugesh Thirunavukarasu, Peoria, IL (US)

(73) Assignee: Caterpillar Inc., Peoria, IL (US)

(21) Appl. No.: 13/779,974

(22) Filed: Feb. 28, 2013

(51) Int. Cl. B05B 12/08

(52) U.S. Cl. CPC B05B 12/087
USPC 239/11; 239/71

(57) ABSTRACT

A liquid delivery system includes an engine and a hydraulic circuit, which includes a hydraulic pump driven by the engine and a hydraulic motor driven by the hydraulic pump. A liquid pump is driven by the hydraulic motor and is configured to provide pressurized liquid along a liquid conduit. A variable orifice spray head is configured to receive the pressurized liquid from the liquid conduit and deliver the pressurized liquid through an opening of the variable orifice spray head. An actuation mechanism is configured to change a size of the opening of the variable orifice spray head responsive to command signals. An electronic control module has a spray head calibration algorithm executable thereon that identifies a correlation, which is stored in memory, between a variable orifice spray head command signal and a target variable orifice spray head opening size based on a hydraulic pressure along the hydraulic circuit.

### TECHNICAL FIELD

The present disclosure relates generally to a system and method for calibrating a variable orifice spray head of a liquid delivery system, and more particularly to correlating a variable orifice spray head command signal to a target variable orifice spray head opening size based on a hydraulic pressure.

### BACKGROUND

Liquid delivery systems are used in a number of different applications to deliver, and distribute, various liquids. For example, in mobile applications, a liquid delivery machine, or truck, may use a liquid delivery system to distribute a liquid, such as water, at construction or mining sites to reduce dust. In particular, for example, a liquid delivery machine may distribute water along haul roads at a work site to minimize the creation of dust during work operations. For various reasons, including cost, efficiency, and safety, it may be desirable to precisely control the amount and distribution of the liquid. For example, in addition to being expensive, an excessive amount of water delivered to a haul road may result in slippery haul roads.

Typical liquid delivery systems are powered by an engine and deliver liquid through spray heads at liquid distribution rates that are directly proportional to the speed of the engine. Thus, desired liquid distribution rates may vary greatly as the engine speed varies, such as when the machine traverses rugged and/or inclined terrain. Some of these machines are fitted with switches to turn on and off the liquid supply to one or more of the spray heads; however, this may become very tedious for the operator. More recently, control strategies have been developed in an attempt to achieve liquid distribution rates that are independent of engine speed. In particular, independently adjustable drive systems have been introduced between the engine and the sprays heads of the liquid distribution system to vary the liquid distribute rates independently from the engine speed. In some cases, however, these strategies may be inefficient and/or may not offer the precise control that is desired.

A system and apparatus for controlling the delivery of fluid from a reservoir is taught in U.S. Pat. No. 7,896,258 to Hoisington et al. In particular, the Hoisington et al. reference discloses a strategy for controlling the delivery of fluid in relation to the ground speed of the vehicle delivering the fluid. An engine driven hydraulic pump and a hydraulic motor, driven by the hydraulic pump, are utilized to drive the delivery of fluid via a fluid pump. A programmable logic controller is programmed to control the hydraulic motor based on the vehicle ground speed to control the fluid pump. Although the strategy of the Hoisington et al. reference may provide liquid distribution rates that are independent of engine speed, the strategy may suffer from the inefficiency and/or imprecision noted above.

The present disclosure is directed to one or more of the problems or issues set forth above.

### SUMMARY OF THE DISCLOSURE

In one aspect, a liquid delivery system includes an engine and a hydraulic circuit, which includes a hydraulic pump driven by the engine and a hydraulic motor driven by the hydraulic pump. A liquid pump is driven by the hydraulic motor and is configured to provide pressurized liquid along a liquid conduit. A variable orifice spray head is configured to receive the pressurized liquid from the liquid conduit and deliver the pressurized liquid through an opening of the variable orifice spray head. An actuation mechanism is configured to change a size of the opening of the variable orifice spray head responsive to command signals. The liquid delivery system also includes an electronic control module having a spray head calibration algorithm executable thereon that identifies a correlation, which is stored in a memory, between a variable orifice spray head command signal and a target variable orifice spray head opening size based at least in part on a hydraulic pressure along the hydraulic circuit.

In another aspect, a method of calibrating a variable orifice spray head of a liquid delivery system includes steps of operating an engine and circulating hydraulic fluid along a hydraulic circuit that includes a hydraulic pump driven by the engine and a hydraulic motor driven by the hydraulic pump. Pressurized liquid is supplied along a liquid conduit using a liquid pump driven by the hydraulic motor. The pressurized liquid is delivered from the liquid conduit through an opening of a variable orifice spray head. A size of the opening of the variable orifice spray head is changed using an actuation mechanism in response to command signals. The method also includes executing a spray head calibration algorithm on an electronic control module. The spray head calibration algorithm identifies a correlation between a variable orifice spray head command signal and a target variable orifice spray head opening size based at least in part on a hydraulic pressure along the hydraulic circuit, and stores the correlation in a memory.

In another aspect, a liquid delivery machine includes a machine frame carried by a plurality of ground engaging members. An engine is supported on the machine frame and drives a hydraulic drive system having a hydraulic pressure. A liquid delivery system is supported on the machine frame and includes a liquid pump driven by the hydraulic drive system and configured to provide pressurized liquid. The liquid delivery system also includes a variable orifice spray head configured to receive the pressurized liquid from the liquid pump and deliver the pressurized liquid through an opening of the variable orifice spray head. The opening of the variable orifice spray head is adjustable through a range of selectable positions in response to command signals. An electronic control module is in control communication with the hydraulic drive system and the liquid delivery system and has a spray head calibration algorithm executable thereon. The spray head calibration algorithm correlates a variable orifice spray head command signal with one of the range of selectable positions of the opening of the variable orifice spray head based on the hydraulic pressure.

### BRIEF DESCRIPTION OF THE DRAWINGS

FIG. 1 is a perspective view of an exemplary embodiment of a liquid delivery machine, according to the present disclosure;

FIG. 2 is a schematic block diagram of an exemplary liquid delivery system suited for use with the liquid delivery machine of FIG. 1;

FIG. 3 is a logic flow diagram of an exemplary embodiment of a spray head calibration algorithm suited for implementation with the liquid delivery system of FIG. 2;

FIG. 4 is a screen shot of an exemplary operator interface configured for use with the liquid delivery system of FIG. 2 and having a depiction of one stage of a spray head calibration procedure; and

FIG. 5 is a screen shot of the operator interface of FIG. 4 having a depiction of another stage of the spray head calibration procedure.

### DETAILED DESCRIPTION

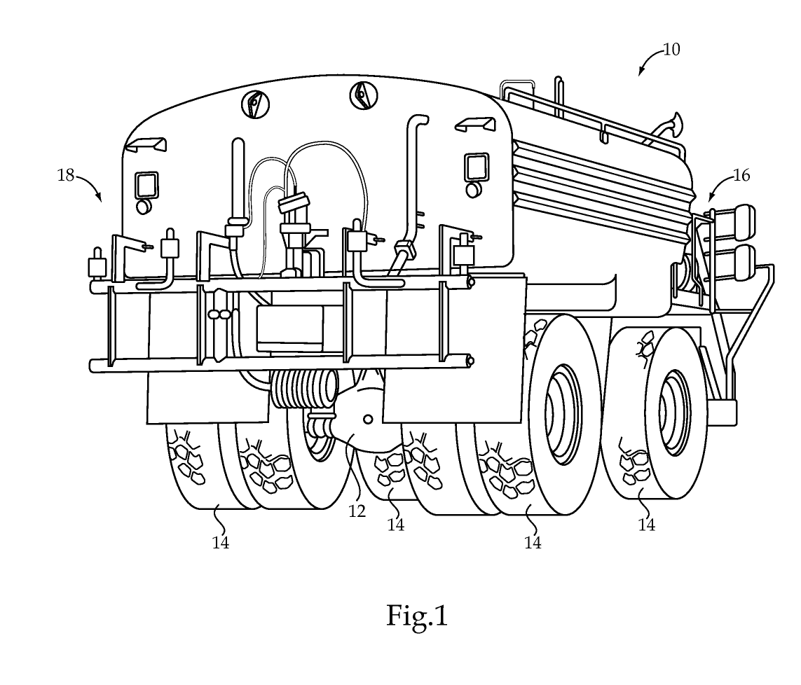

An exemplary embodiment of a liquid delivery machine 10 is shown generally in FIG. 1. The liquid delivery machine 10 is shown as an off-highway truck configured for delivering liquids. Although a particular machine is shown it should be appreciated that various mobile machines and stationary applications configured for the delivery of liquid are suited for use with the teachings presented herein. The liquid delivery machine 10 generally includes a machine frame 12 carried by a plurality of ground engaging members 14. Although different arrangements are contemplated, the liquid delivery machine 10 may also have an operator control station 16 supported on the machine frame 12 and including common devices that facilitate operator control. Among other systems, a liquid delivery system 18 may also be supported on the machine frame 12.

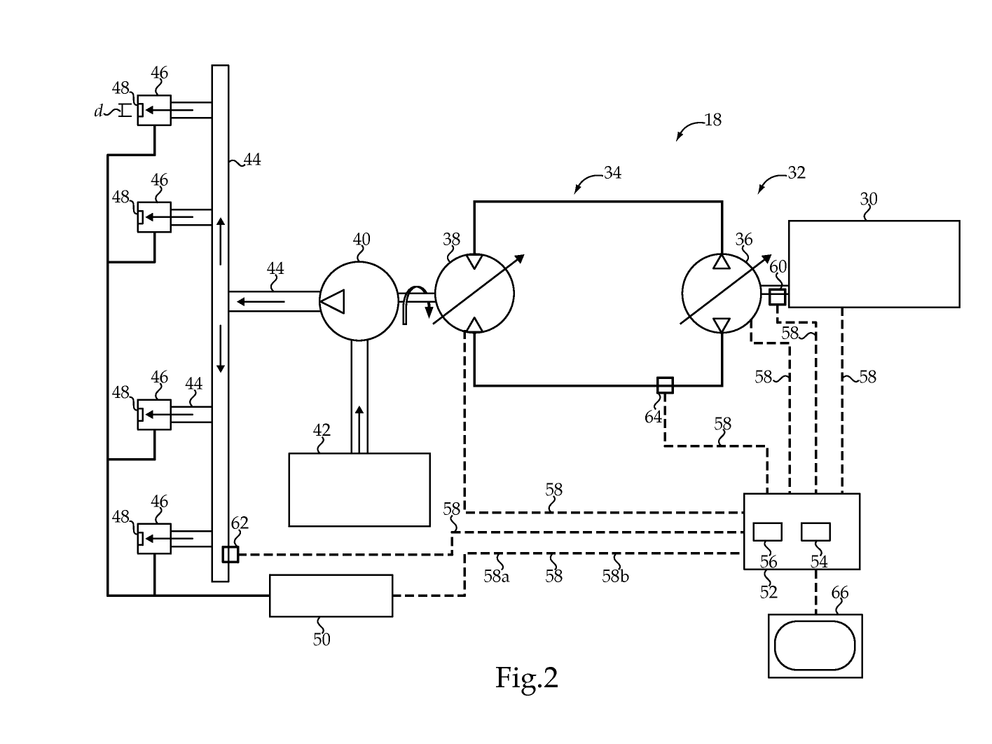

Turning now to FIG. 2, the liquid delivery system 18 will be discussed in greater detail. The liquid delivery system 18 may include an engine 30, such as an internal combustion engine or other power source, which may be supported on the machine frame 12 shown in FIG. 1. The engine 30 may be configured to provide power to a number of systems and devices in addition to the liquid delivery system 18. As shown, the liquid delivery system 18 may also include a hydraulic drive system 32 powered by the engine 30. The hydraulic drive system 32, which may also be supported on the machine frame 12, may include a hydraulic circuit 34 defined by a hydraulic pump 36 driven by the engine 30 and a hydraulic motor 38 driven by the hydraulic pump 36. One or both of the hydraulic pump 36 and the hydraulic motor 38 may offer swash plate type variable displacement, as is known in the art.

The liquid delivery system 18 may also include a liquid pump 40, which may be driven by the hydraulic motor 38 of the hydraulic drive system 32. The liquid pump 40 may be configured to draw liquid from a liquid supply 42, such as a tank supported on the machine frame 12 of FIG. 1, and provide pressurized liquid along a liquid conduit 44. The liquid conduit 44 may feed one or more variable orifice spray heads 46. Although four variable orifice spray heads 46 are shown, it should be appreciated that alternative numbers of variable orifice spray heads 46 may be utilized, depending on the particular application. Each variable orifice spray head 46 is configured to receive pressurized liquid from the liquid conduit 44 and deliver the pressurized liquid through an opening 48 of the respective variable orifice spray head 46. As described herein, the opening 48 of the variable orifice spray head 46 is adjustable through a range of selectable positions between a fully open position and a fully closed position. To facilitate adjustment between the range of selectable positions, an actuation mechanism 50 may be configured to change a size of the opening 48 of each of the variable orifice spray heads 46 in response to command signals, as will be described below.

An electronic control module 52 may be programmed to control only the liquid delivery system 18 or additional components and systems of the liquid delivery machine 10. The electronic control module 52 may be of standard design and may include a processor 54, such as, for example, a central processing unit, a memory 56, and an input/output circuit that facilitates communication internal and external to the electronic control module 52. The processor 54, for example, may control operation of the electronic control module 52 by executing operating instructions, such as, for example, computer readable program code stored in memory 56, wherein operations may be initiated internally or externally to the electronic control module 52.

Control schemes may be utilized that monitor outputs of systems or devices, such as, for example, sensors, actuators, or control units, via the input/output circuit to control inputs to various other systems or devices. The memory 56, as used herein, may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. One skilled in the art will appreciate that any computer based system or device utilizing similar components for controlling the machine systems or components described herein, is suitable for use with the present disclosure.

The electronic control module 52 may communicate with various systems and devices of the liquid delivery system 18 and/or liquid delivery machine 10 via one or more wired and/or wireless communications lines 58, or other similar input/output circuits. For example, the electronic control module 52 may communicate with at least the engine 30, one or more components of the hydraulic drive system 32, and the actuation mechanism 50. Sensors, or other similar devices, which may also communicate with the electronic control module 52 via communications lines 58, may represent a variety of sensors used by the electronic control module 52 to monitor and control operation of the liquid delivery system 18 and/or liquid delivery machine 10. For example, the electronic control module 52 may be in communication with an engine speed sensor 60 configured to detect a speed of the engine 30, a liquid pressure sensor 62 configured to detect a liquid pressure along or adjacent the liquid conduit 44, and a hydraulic pressure sensor 64 configured to detect a hydraulic pressure along the hydraulic circuit 34. The electronic control module 52 may also be in communication with an operator interface 66, which may be positioned within the operator control station 16 of FIG. 1.

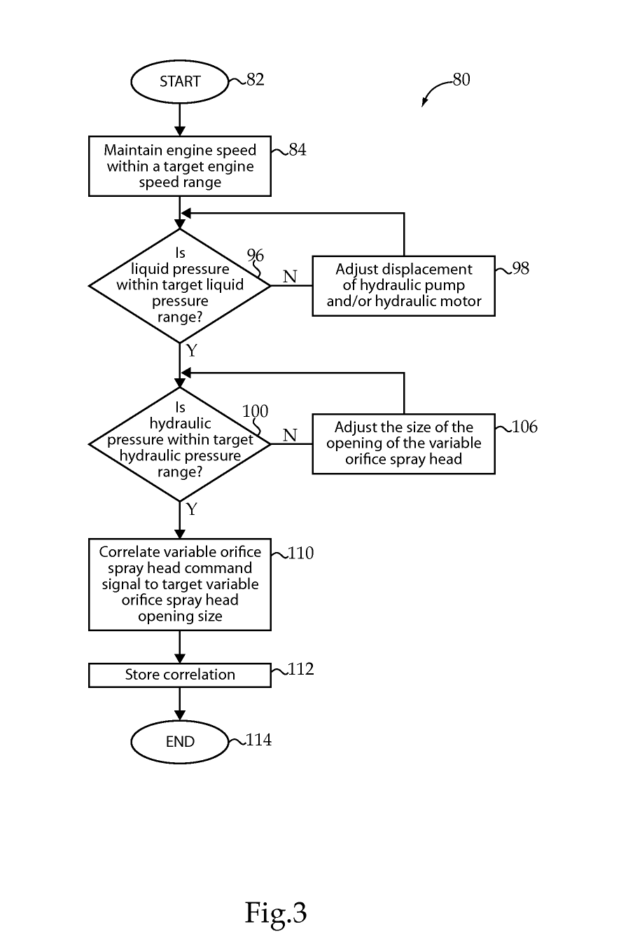

Turning now to FIG. 3, there is shown an exemplary spray head calibration algorithm 80, represented as a logic flow diagram, for the liquid delivery system 18, according to the present disclosure. The spray head calibration algorithm 80 identifies a correlation between a variable orifice spray head command signal, shown at 58a in FIG. 2, and a target variable orifice spray head opening size, shown, for example, at d in FIG. 2, based at least in part on a hydraulic pressure along the hydraulic circuit 34. In particular, the spray head calibration algorithm 80 may correlate the variable orifice spray head command signal 58a with one of the range of selectable positions of the opening 48 of the variable orifice spray head 46. As will be discussed below, the spray head calibration algorithm 80 may identify the correlation based on the hydraulic pressure, a liquid pressure along the liquid conduit 44, and a speed of the engine 30. As such, a set of target values, discussed below and including a target engine speed, a target liquid pressure, and a target hydraulic pressure, corresponding to the target variable orifice spray head opening size d may be stored in memory 56, along with corresponding target ranges.

The spray head calibration algorithm 80, or method, may be implemented by the electronic control module 52, or other similar electronic control device, of the liquid delivery machine 10. According to one example, the steps implementing the disclosed spray head calibration algorithm 80 may be in the form of computer readable program code stored in the memory 56 of the electronic control module 52 and executed by the processor 54 of the electronic control module 52. The spray head calibration algorithm 80 may run, or initiate, responsive to an operator request.

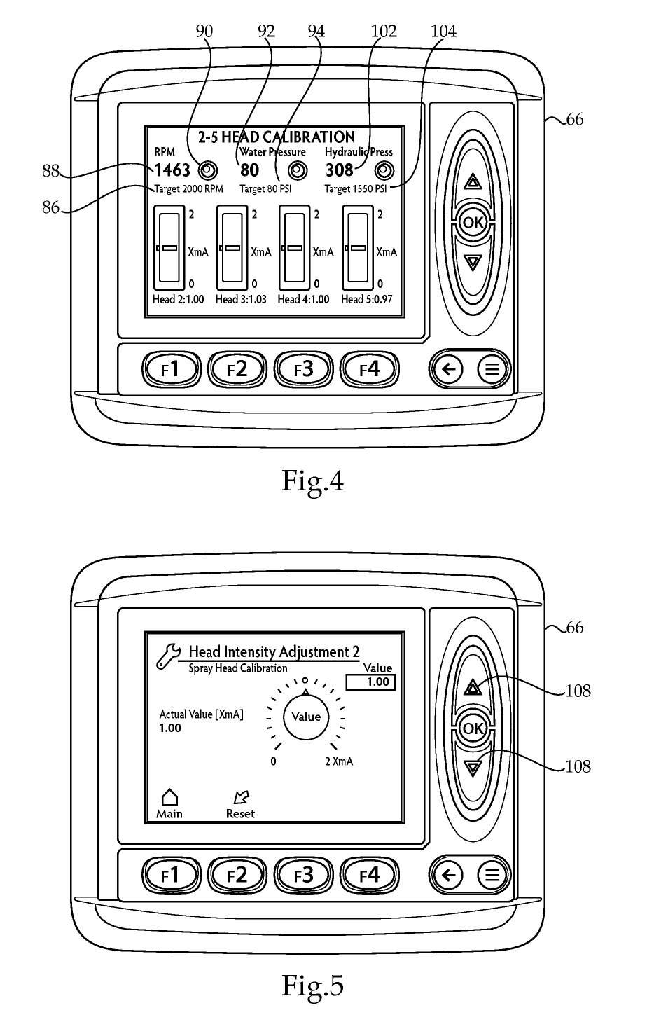

The spray head calibration algorithm 80 begins at a START, Box 82. From Box 82, the spray head calibration algorithm 80 proceeds to Box 84, which includes the step of maintaining the engine speed within a target engine speed range. In particular, and referring also to FIG. 4, the spray head calibration algorithm 80 may induce display of a target engine speed 86, which may be stored in memory 56, on the operator interface 66. The operator interface 66 may also induce display of the engine speed 88, as determined from the engine speed sensor 60, and may prompt the operator to set and maintain the engine speed 88 within a target engine speed range that includes the target engine speed 86 and represents an acceptable deviation above and below the target engine speed 86. The spray head calibration algorithm 80 may also induce display of an indication that the engine speed 88 is within the target engine speed range. For example, an indicator 90 may be provided on the operator interface 66 and may change between at least two different states to inform the operator when the target engine speed 86, or target engine speed range, has been reached.

Referring to FIGS. 2 and 4, and according to a subsequent step of the spray head calibration algorithm 80, the electronic control module 52 may adjust a liquid pressure 92, as determined from the liquid pressure sensor 62, toward a target liquid pressure 94, or liquid pressure range, from memory 56. In particular, and according to the exemplary embodiment, the electronic control module 52 may determine if the liquid pressure 92 is within a target liquid pressure range, at Box 96. If the liquid pressure 92 is not within the target liquid pressure range, the electronic control module 52 may adjust one or both of the hydraulic pump 36 and the hydraulic motor 38, at Box 98, until the liquid pressure 92 is within the target liquid pressure range. The spray head calibration algorithm 80 may induce display of the liquid pressure 92 and the target liquid pressure 94 on the operator interface 66, as shown in FIG. 4. Further, the spray head calibration algorithm 80 may induce display of an indication that the liquid pressure 92 is within a target liquid pressure range that includes the target liquid pressure 94.

Next, at Box 100, a hydraulic pressure 102, as may be determined by the hydraulic pressure sensor 64, may be monitored until a target hydraulic pressure 104 and/or range is reached. The spray head calibration algorithm 80 may induce display of both of the hydraulic pressure 102 and the target hydraulic pressure 104 on the operator interface 66. Referring to Box 100, the spray head calibration algorithm 80 may determine whether the hydraulic pressure 102 is within the target hydraulic pressure range. If the hydraulic pressure 102 is not within the target hydraulic pressure range, the operator may be prompted, or permitted, to adjust the size of the opening 48 of the variable orifice spray head 46 in order to adjust the hydraulic pressure 102, as shown at Box 106.

For example, as shown in FIG. 5, the operator may be prompted to increase or decrease the opening size of the variable orifice spray head 46 by manipulating controls, such as, for example, controls 108, on the operator interface 66. This adjustment may be continued until the hydraulic pressure 102 is within an acceptable deviation from the target hydraulic pressure 104. When the hydraulic pressure 102 is within this acceptable target hydraulic pressure range, the spray head calibration algorithm 80 may induce display of an indication that the hydraulic pressure 102 has reached the target hydraulic pressure 104 or the target hydraulic pressure range.

According to one exemplary embodiment, the actuation mechanism 50 for adjusting the openings 48 of the variable orifice spray heads 46 may include a hydraulic valve pack. The hydraulic valve pack may permit the openings 48 of each of the variable orifice spray heads 46 to be independently controlled. In particular, the electronic control module 52 may transmit a control signal via communications lines 58 to the actuation mechanism 50 corresponding to a particular one of the variable orifice spray heads 46 and inducing adjustment of the respective opening 48. For example, the electronic control module 52 may transmit a control signal having an increased amperage, or voltage, or a decreased amperage, or voltage, in order to respectively increase or decrease the size of the opening 48 of the variable orifice spray head 46.

Once the engine speed 88, liquid pressure 92, and hydraulic pressure 102 match, or substantially match, the respective one of the set of target values 86, 94, and 104, the variable orifice spray head command signal, for example, 58a, which is used to achieve the current opening size of the variable orifice spray head 46, is correlated to the target variable orifice spray head opening size d, at Box 110. The correlation is thereafter stored in memory 56, at Box 112, and is available for subsequent reference. For example, the electronic control module 52 may issue a subsequent variable orifice spray head command signal, for example, 58b, based on a desired liquid deposition rate and the correlation. In particular, the operator may select a desired liquid deposition rate, either directly or by selecting a particular operation mode. In response, the electronic control module 52 may set a constant liquid pressure 92, independent of the engine speed 88, and then vary the flow rate through individual variable orifice spray heads 46 by adjusting the opening 48 of each variable orifice spray head 46.

By properly correlating a particular control signal to the target variable orifice spray head opening size d, precise control of subsequent adjustments may be made. In particular, the variable orifice spray head command signal 58a may represent a predetermined amperage or voltage. Once the predetermined amperage or voltage is correlated to the target variable orifice spray head opening size d, known adjustments may be made to the amperage, or voltage, to achieve different ones of the range of selectable positions of each variable orifice spray head 46. Once the correlation is made and stored, the spray head calibration algorithm 80 proceeds to an END, Box 114. The spray head calibration algorithm 80 may be repeated for each of the variable orifice spray heads 46.

### INDUSTRIAL APPLICABILITY

The present disclosure may be applicable to liquid delivery systems, such as liquid delivery systems that may be supported on a liquid delivery machine or truck. Further, the present disclosure may be applicable to liquid delivery systems having variable orifice spray heads. Yet further, the present disclosure may be applicable to liquid delivery systems having liquid pressure that is controlled independently from an engine speed. Further the present disclosure relates to strategies for calibrating the variable orifice spray heads used in these systems.

Referring generally to FIGS. 1-5, a liquid delivery machine 10 may include a liquid delivery system 18, which may, for example, be used for delivering liquid at a work site to reduce dust during work operations. The liquid delivery system 18 may include an engine 30 providing power to a hydraulic drive system 32. The hydraulic drive system 32 may include a hydraulic pump 36 driven by the engine 30 and a hydraulic motor 38. A liquid delivery pump 40 may be driven by the hydraulic motor 38 and may be configured to provide pressurized liquid along a liquid conduit 44. One or more variable orifice spray heads 46 may receive pressurized liquid from the liquid conduit 44 and deliver pressurized liquid through an opening 48 of the respective variable orifice spray head 46. An actuation mechanism 50 may be configured to change a size of the opening 48 of the variable orifice spray head 48 responsive to command signals. To fully gain the benefit of the independent flow control offered by the variable orifice spray heads 46, each of the variable orifice spray heads 46, or openings 48 thereof, should be accurately calibrated.

It has been discovered that for a particular engine speed 88 and liquid pressure 92, the load produced by the variable orifice spray head 46 at a selected one of the range of selectable positions of the opening 48 results in a unique hydraulic pressure 102. As such, the spray head calibration algorithm 80 disclosed herein utilizes a set of target values, including a target engine speed 86, a target liquid pressure 94, and a target hydraulic pressure 104, that correspond to a target variable orifice spray head opening size d. In particular, the exemplary embodiment of the spray head calibration algorithm 80 described herein maintains the engine speed 88 and liquid pressure 92 at or near the respective target values 86 and 94 and then prompts adjustment of the opening 48 of the variable orifice spray head 46 using command signals until the hydraulic pressure 102 reaches the target hydraulic pressure 104. When the set of target values 86, 94, and 104 is achieved, the variable orifice spray head command signal 58a, or current command signal, may be properly correlated to the target variable orifice spray head opening size d.

The spray head calibration algorithm 80 may be executable on an electronic control module 52 of the liquid delivery machine 10 and/or liquid delivery system 18 to calibrate each of the variable orifice spray heads 46. The spray head calibration algorithm 80 may be initiated by an operator and may require input and/or action by the operator. The spray head calibration algorithm 80 is executed while the liquid delivery system 18 is running, and may only be required when initially configuring the liquid delivery machine 10 and/or when one or more of the variable orifice spray heads 46 are replaced. It should be appreciated that the spray head calibration algorithm 80 may be executed while the engine 30 is running, hydraulic fluid is circulated along the hydraulic circuit 34, and pressurized liquid is being supplied through the opening 48 of each of the variable orifice spray heads 46.

An operator interface 66, described above, may be utilized to facilitate the interactive execution of the spray head calibration algorithm 80. For example, the operator may be prompted to maintain the current speed 88 of the engine 30 at or near the target engine speed 86. When the target engine speed 86 is reached, the electronic control module 52 may adjust the hydraulic drive system 32 to achieve the target liquid pressure 94 or target liquid pressure range. Once the target engine speed 86 and target liquid pressure 94 have been reached, the operator may be prompted to adjust the opening size of the variable orifice spray head 46 being calibrated until the target hydraulic pressure 104 is achieved. Once the target hydraulic pressure 104 is also achieved, a correlation between the variable orifice spray head command signal 58a and the target variable orifice spray head opening size d is made and stored in memory 56.

The correlation strategy disclosed herein provides an accurate and efficient means for calibrating the variable orifice spray heads 46 that can be done by a single operator while onboard the liquid delivery machine 10. Utilizing variable orifice spray heads provides the ability to vary the liquid flow rate independent of both the engine speed 88 and the liquid pressure 92. However, if the variable orifice spray heads 46 are not precisely calibrated, as detailed herein, the benefits may be lost.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A liquid delivery system, comprising:
an engine;
a hydraulic circuit including a hydraulic pump driven by the engine and a hydraulic motor driven by the hydraulic pump;
a liquid pump driven by the hydraulic motor and configured to provide pressurized liquid along a liquid conduit;
a variable orifice spray head configured to receive the pressurized liquid from the liquid conduit and deliver the pressurized liquid through an opening of the variable orifice spray head;
an actuation mechanism configured to change a size of the opening of the variable orifice spray head responsive to command signals; and
an electronic control module having a spray head calibration algorithm executable thereon, wherein the spray head calibration algorithm identifies a correlation between a variable orifice spray head command signal and a target variable orifice spray head opening size based at least in part on a hydraulic pressure along the hydraulic circuit, and stores the correlation in a memory.

2. The liquid delivery system of claim 1, wherein the spray head calibration algorithm identifies the correlation based on the hydraulic pressure, a liquid pressure along the liquid conduit, and a speed of the engine.

3. The liquid delivery system of claim 2, wherein the memory stores a set of target values including a target engine speed value, a target liquid pressure value, and a target hydraulic pressure value corresponding to the target variable orifice spray head opening size.

4. The liquid delivery system of claim 3, wherein the electronic control module is in communication with an operator interface and the spray head calibration algorithm induces display of the set of target values on the operator interface.

5. The liquid delivery system of claim 4, wherein the electronic control module is in communication with an engine speed sensor configured to detect the engine speed, wherein the spray head calibration algorithm induces display of the engine speed on the operator interface.

6. The liquid delivery system of claim 5, wherein the spray head calibration algorithm induces display of an indication that the engine speed is within a target engine speed range including the target engine speed.

7. The liquid delivery system of claim 4, wherein the electronic control module is in communication with a liquid pressure sensor configured to detect the liquid pressure, wherein the spray head calibration algorithm adjusts the liquid pressure toward the target liquid pressure by adjusting a displacement of at least one of the hydraulic pump and the hydraulic motor.

8. The liquid delivery system of claim 7, wherein the spray head calibration algorithm induces display of the liquid pressure on the operator interface.

9. The liquid delivery system of claim 8, wherein the spray head calibration algorithm induces display of an indication that the liquid pressure is within a target liquid pressure range including the target liquid pressure.

10. The liquid delivery system of claim 4, wherein the electronic control module is in communication with a hydraulic pressure sensor configured to detect the hydraulic pressure, wherein the spray head calibration algorithm induces display of the hydraulic pressure on the operator interface.

11. The liquid delivery system of claim 10, wherein the spray head calibration algorithm induces display of an indication that the hydraulic pressure is within a target hydraulic pressure range including the target hydraulic pressure.

12. The liquid delivery system of claim 11, wherein the hydraulic pressure changes as the size of the opening of the variable orifice spray head changes.

13. A method of calibrating a variable orifice spray head of a liquid delivery system, comprising steps of:
operating an engine;
circulating hydraulic fluid along a hydraulic circuit that includes a hydraulic pump driven by the engine and a hydraulic motor driven by the hydraulic pump;
supplying pressurized liquid along a liquid conduit using a liquid pump driven by the hydraulic motor;
delivering the pressurized liquid from the liquid conduit through an opening of a variable orifice spray head;
changing a size of the opening of the variable orifice spray head using an actuation mechanism in response to command signals; and
executing a spray head calibration algorithm on an electronic control module, wherein the spray head calibration algorithm identifies a correlation between a variable orifice spray head command signal and the target variable orifice spray head opening size based at least in part on a hydraulic pressure along the hydraulic circuit, and stores the correlation in a memory.

14. The method of claim 13, wherein executing the spray head calibration algorithm includes identifying the correlation based on the hydraulic pressure, a liquid pressure along the liquid conduit, and a speed of the engine.

15. The method of claim 14, further including storing a set of target values including a target engine speed value, a target liquid pressure value, and a target hydraulic pressure value corresponding to the target variable orifice spray head opening size in the memory.

16. The method of claim 15, wherein executing the spray head calibration algorithm further includes maintaining the engine speed within a target engine speed range including the target engine speed.

17. The method of claim 16, wherein executing the spray head calibration algorithm further includes adjusting the liquid pressure toward the target liquid pressure by adjusting a displacement of at least one of the hydraulic pump and the hydraulic motor.

18. The method of claim 17, wherein executing the spray head calibration algorithm further includes adjusting the hydraulic pressure toward the target hydraulic pressure by changing the size of the opening of the variable orifice spray head.

19. The method of claim 13, further including issuing a subsequent variable orifice spray head command signal based on a desired liquid deposition rate and the correlation using the electronic control module.

20. A liquid delivery machine, including:
a machine frame carried by a plurality of ground engaging members;
an engine supported on the machine frame;
a hydraulic drive system driven by the engine and having a hydraulic pressure;
a liquid delivery system supported on the machine frame and including:
a liquid pump driven by the hydraulic drive system and configured to provide pressurized liquid; and
a variable orifice spray head configured to receive the pressurized liquid from the liquid pump and deliver the pressurized liquid through an opening of the variable orifice spray head, wherein the opening is adjustable through a range of selectable positions in response to command signals; and
an electronic control module in control communication with the hydraulic drive system and the liquid delivery system and having a spray head calibration algorithm executable thereon, wherein the spray head calibration algorithm correlates a variable orifice spray head command signal with one of the range of selectable positions of the opening of the variable orifice spray head based on the hydraulic pressure.
